(19) United States
(12) Patent Application Publication
(10) Pub. No.: US 2005/0209815 A1
(43) Pub. Date: Sep. 22, 2005

(54) Method, system, and computer-readable medium for user-assignment of geographic data to an image file

(76) Inventors: Virgil Kay Russon, Greeley, CO (US); Michael Lawrence Rudd, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/790,947

(22) Filed: Mar. 2, 2004

(51) Int. Cl. G06F 15/00

(52) U.S. Cl. 702/150

(57) ABSTRACT

A system for associating geographic data with an image data set comprises an input device operable to receive user input provided thereto and a memory device adapted to store an image data set is provided. The user supplied input specifies geographic data and the system associates the geographic data with the image data set.

### TECHNICAL FIELD

This invention relates to imaging technologies and, more particularly, to a method, system, and computer-readable medium for user-assignment of geographic data to an image file.

### BACKGROUND

The global positioning system (GPS) comprises a constellation of satellites that broadcast respective positions that can be received by terrestrial or airborne receivers. A GPS receiver triangulates the GPS signals received from the satellites and calculates a position resolved in latitude and longitude coordinates. The GPS is owned by the U.S. Department of Defense and has numerous military applications. A number of specialized applications have evolved for GPS. For instance, scientists use GPS receivers to monitor movements in Earth's tectonic plates. Consumer products using GPS have become available for various outdoor activities. A common commercial GPS application is navigation systems included in automobiles.

Recently, GPS-enabled cameras have been developed that encode location data in images taken with a camera. For example, a digital camera with an embedded GPS receiver can enter location-of-receiver information in a header field of a digitally-encoded photograph. However, GPS-enabled photography systems are relatively expensive and cumbersome to operate.

### SUMMARY OF THE INVENTION

In accordance with an embodiment of the present invention, a method of associating geographic data with a computer-readable image data set comprising receiving a user input identifying a geographic location to associate with an image data set and associating the geographic location with the image data set is provided.

In accordance with another embodiment of the present invention, a system for associating geographic data with an image data set comprising an input device operable to receive user input provided thereto and a memory device adapted to store an image data set is provided. The user supplied input specifies geographic data and the system associates the geographic data with the image data set.

In accordance with yet another embodiment of the present invention, a computer-readable medium having stored thereon an instruction set to be executed, the instruction set, when executed by a processor, causes the processor to receive a user input specifying a geographic location and associate geographic data of the location with an image file is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of a computer system operable to run a geographic imaging application that facilitates user-assignment of geographic data to an image according to embodiments of the invention;

FIG. 2A is a simplified schematic of a data set that may be manipulated in accordance with embodiments of the invention;

FIG. 2B is an image defined by the image data set described with reference to FIG. 2A;

FIG. 3 is an embodiment of a geographic map defined by a computer-readable data set that facilitates user-assignment of geographic data with the image data set described with reference to FIG. 2A;

FIG. 4A is a schematic of a graphical user interface that displays the map described with reference to FIG. 3, and that facilitates user assignment of geographic data to an image file in accordance with embodiments of the invention;

FIG. 4B is a schematic of a graphical user interface that displays a magnified portion of the map described with reference to FIG. 3 according to a user selection in accordance with embodiments of the invention;

FIGS. 5A and 5B are schematics of a graphical user interface that facilitates user-association of location data with an image file in accordance with embodiments of the invention;

FIG. 6A is a schematic of a table used to store geographic locations and corresponding global positioning system data that facilitates user-assignment of GPS data with an image file in accordance with embodiments of the invention; and

FIG. 6B is a schematic of a return data set generated by querying the tables described with reference to FIG. 6A, and that facilitates user-assignment of geographic data to an image file in accordance with embodiments of the invention.

### DETAILED DESCRIPTION OF THE DRAWINGS

The preferred embodiment of the present invention and its advantages are best understood by referring to FIGS. 1 through 6 of the drawings, like numerals being used for like and corresponding parts of the various drawings.

Embodiments of the present invention provide techniques that facilitate user-assignment, or association, of geographic data with a computer-readable image data set, and thus an image defined thereby, without the need of a GPS-enabled camera or GPS receiver and the like. Thus, an image file may be captured with an imaging device that lacks GPS capabilities and the image data set is then manipulated such that desired geographic data is associated therewith. In one embodiment, the user is able to select an image data set and utilize a drag-and-drop technique for associating desired geographic data with data set 131. If the desired geographic data is already associated with the image file, then the existing data is recognized. Thus, images without the desired geographic data may be brought to the same level of functionality as images with the desired geographic data.

FIG. 1 is a simplified block diagram of a computer system 100 operable to execute a geographic imaging application 160 that facilitates user-assignment of geographic data with an image according to an embodiment of the present invention. Computer system 100 comprises at least one central processing unit 30 connected to a memory and input/output controller (MIOC) 10 via a system bus 35. MIOC 10 receives access requests over system bus 35 and addresses memory device 40 and/or other input/output (I/O) devices communicatively coupled with a local interface 50, such as one or more buses. For example, a printer 20, a display device 21, a pointer device (such as a mouse 22), a keyboard 23, an I/O port 24, and a storage device 25 are communicatively coupled with MIOC 10 via local interface 50. Memory device 40 may be implemented as non-volatile storage, such as a read only memory (ROM), a volatile storage, such as a random-access memory (RAM), a dynamic random-access memory, a flash electrically-erasable programmable read only memory, or another storage device.

An image file comprises a computer-readable data set 131 captured by a digital imaging device, such as a digital camera or scanner, and may comprise any suitable image file format. Data set 131 will be described with reference to the exchangeable image file (EXIF) format to facilitate an understanding of the invention. However, embodiments of the present invention are not limited to a particular file format and may be applied to any one of various well-known formats or may be implemented with an image file format later developed. Data set 131 may be transferred to system 100 from a digital cameral or other device via I/O port 24 or by way of another mechanism.

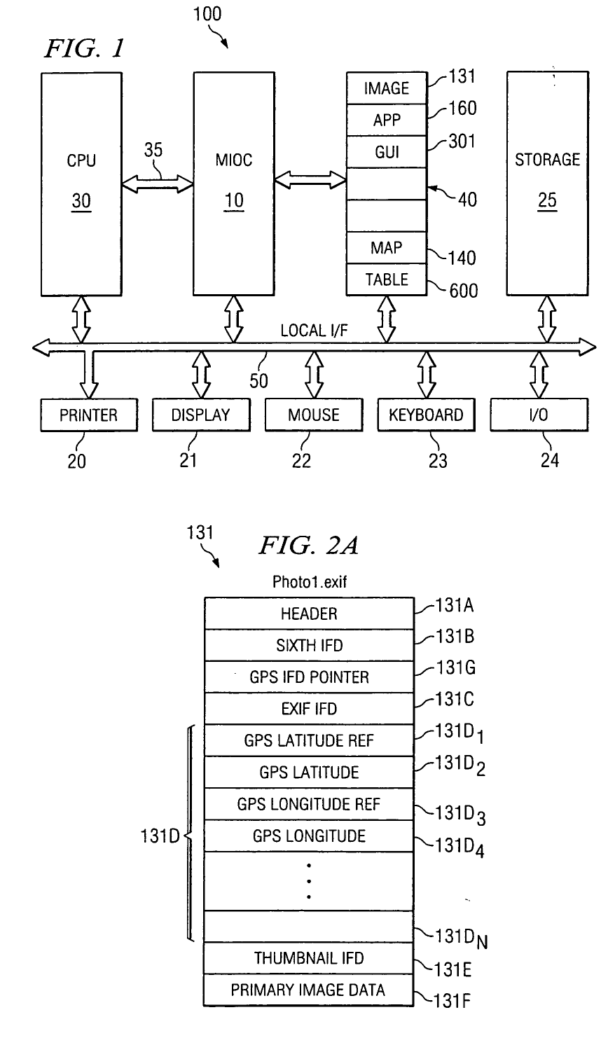

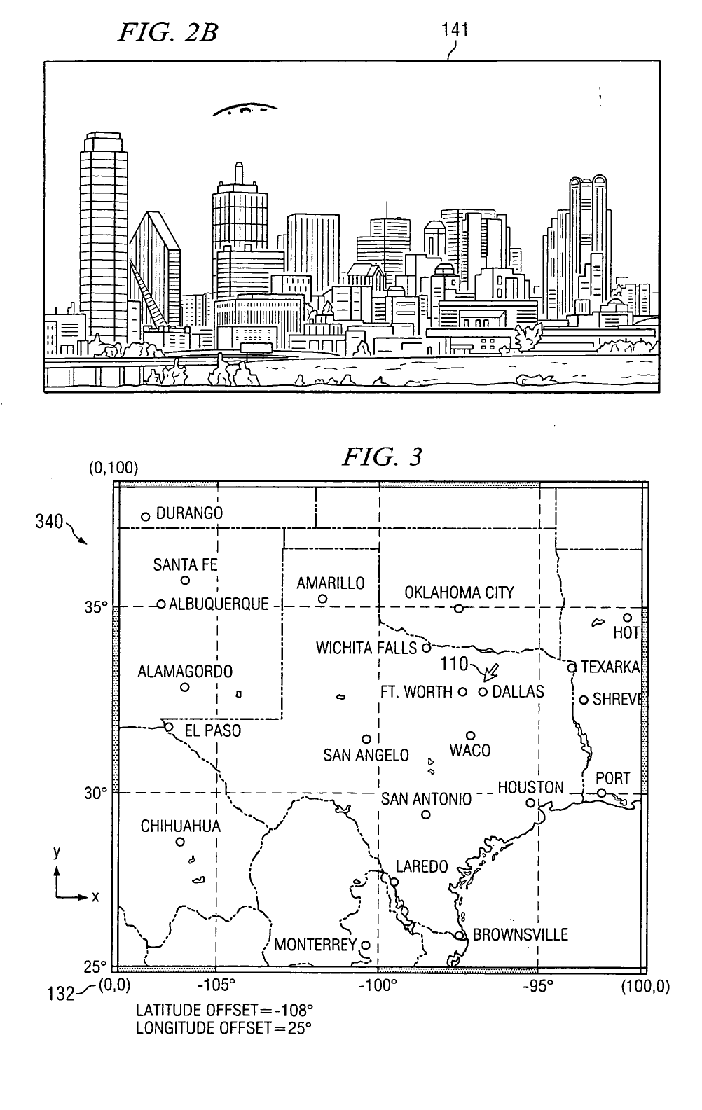

Turning now to FIG. 2A, a simplified schematic of data set 131 is shown formatted according to the EXIF version 2.1 format, and that may be manipulated in accordance with embodiments of the invention. In general, data set 131 comprises various data fields in addition to image data. An 8-byte header 131A specifies a byte order and an offset to an image file directory (IFD). The EXIF format provides two image file directories—a 0th IFD 131B that stores attribute information of the primary image and an optional Thumbnail IFD 131E that stores attribute data of a thumbnail image. Additionally, a GPS IFD 131D is provided and is referenced by a GPS IFD pointer 131G. Tags, or fields, are provided that specify particular attributes of the image data and are stored in the various IFDs. Tags are specified by a unique 2-byte number that identifies the associated tag field within the relevant IFD. Specific information on IFDs 131B, 131C and 131E and the associated tags are documented in the EXIF v2.1 specification. Primary image data is stored in a field 131F that defines an image 141 displayed by processing of data set 131. For illustrative purposes, image 141 defined by image data set 131 comprises a skyline photograph of the city of Dallas, Tex. as shown by FIG. 2B. Data set 131 generally includes a label, or filename, and in the illustrative example, data set 131 has a filename of photo1.exif.

GPS IFD 131D comprises a collection of fields 131D₁-131D_{N} for recording GPS information associated with image 141 defined by data set 131. TABLE A summarizes exemplary GPS fields 131D₁-131D_{N} that may be utilized in embodiments of the invention for enabling user assignment of GPS data with image data set 131. Numerous other GPS-related fields are provided for by data set 131, and may be subject to manipulation in accordance with the teachings of the invention. The particular fields summarized in TABLE A are for illustrative purposes only.

TABLE A

| Tag Name | Field Name | Tag ID | Type |
|---|---|---|---|
| North/South Latitude | GPSLatitudeRef | 1 | ASCII |
| Latitude | GPSLatitude | 2 | Rational |
| East/West Longitude | GPSLongitudeRef | 3 | ASCII |
| Longitude | GPSLongitude | 4 | Rational |

The North/South Latitude tag references a GPSLatitudeRef field 131D₁ that maintains an American Standard Code for Information Interchange (ASCII) formatted identifier specifying whether the latitude value references a north or south latitude. An ASCII value of “N” indicates the latitude measurement is a north latitude and an ASCII value of “S” indicates the latitude value references a south latitude. The Latitude tag references a GPSLatitude field 131D₂ that maintains a rational measurement of the latitude. The latitude value stored in GPSLatitude field 131D₂ may comprise up to three rational values that specify the latitude in degrees, minutes, and seconds. Similarly, the East/West Longitude tag references a GPSLongitudeRef field 131D₃ that maintains an ASCII-formatted identifier specifying whether the longitude value references an east or west longitude. An ASCII value of “E” indicates the longitude measurement is an east longitude value and an ASCII value of “W” indicates the longitude measurement is a west longitude value. A longitude value stored in a GPSLongitude field 131D₄ may comprise up to three rational values that specify the longitude degree, minute and second.

Imaging application 160 preferably comprises a set of computer-readable instructions and is adapted to derive data that specifies a geographic location, e.g., GPS latitude and longitude values, from user-input. The user input preferably specifies a location identity, e.g., a city name, landmark, or the like, and may comprise an input provided by a pointer device, text supplied to a keyboard, a touch-sensitive screen, or another suitable input. Preferably, application 160 comprises a data set parser and writer adapted to address an IFD and associated tags of data set 131. In the exemplary embodiments described herein, application 160 is operable to parse EXIF-formatted data set 131 and write geographic data to one or more GPS fields. However, other fields, such as user defined fields of an image data set, may be written to by application 160 as well.

FIG. 3 illustrates a geographic map 340 defined by a computer-readable data set 140 (FIG. 1) that facilitates user-assignment of geographic data with image 141 in accordance with embodiments of the invention. Data set 140 is retrievable by processor 30 from memory device 40 and displayable on display device 21. Data set 140 may comprise any suitable image file, such as a bitmap file, a joint photographic experts group file, an exchangeable image file, or another data set suitably formatted for processing by a computational device and outputting on display device 21.

Preferably, map 340 is associated with a coordinate reference 132, such as a Cartesian coordinate system, for enabling a user to select or otherwise specify a location of the geographic map with a pointer 110 by user input supplied to mouse 22 or another input device. In the illustrative example, the coordinate system has an origin (0,0) and extends from 0 to 100 along both the x-axis and y-axis. In accordance with an embodiment of the invention, latitude and longitude offsets (LatOffset and LongOffset) are associated with an origin or other reference of map 340 and facilitates conversion of a pointer coordinate to a latitude and longitude value. In the illustrative example, a longitude offset of 25 degrees and a latitude offset of −108 degrees is associated with coordinate reference 132. A position of a pointer 110 identified by an x- and y-coordinate is convertible to GPS data by imaging application 160. For example, GPS longitude and latitude values may be respectively derived from a pointer coordinate according to the following equations:
GPSlong=X-COOR*LongScale+LongOffset (eq. 1)
GPSLat=Y-COOR*LatScale+LatOffset, (eq. 2)
where X-COOR and Y-COOR are the x- and y-coordinates of pointer 110, LongOffset and LatOffset are the longitude and latitude offset values of coordinate reference 132, and LongScale and LatScale are ratios of the longitude and latitude span of map 340 to respective x- and y-coordinate spans.

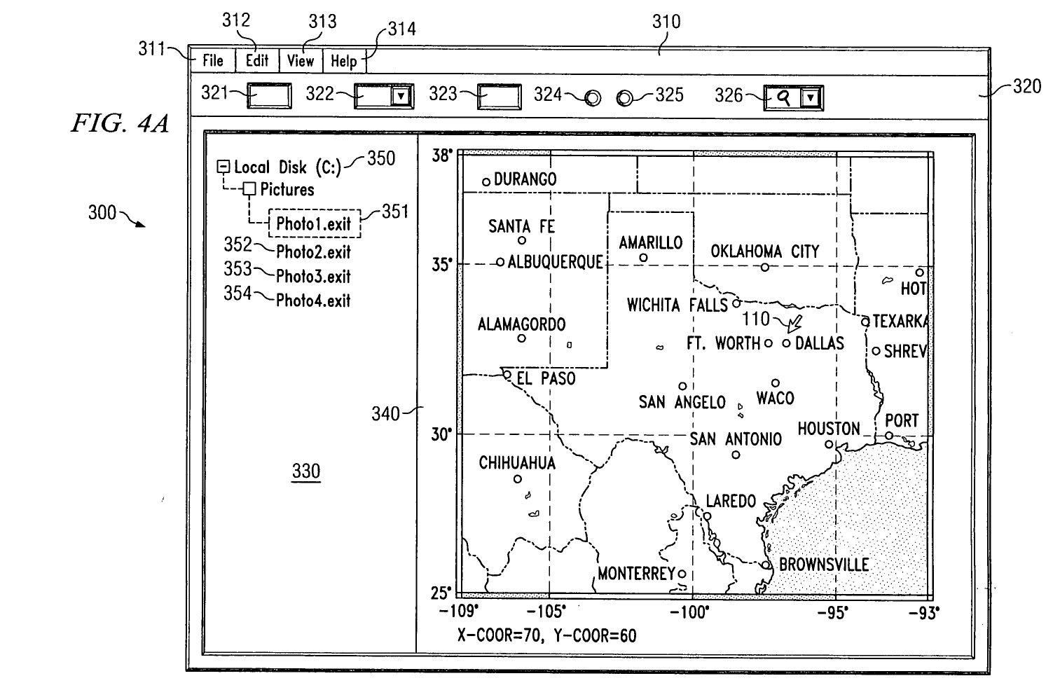

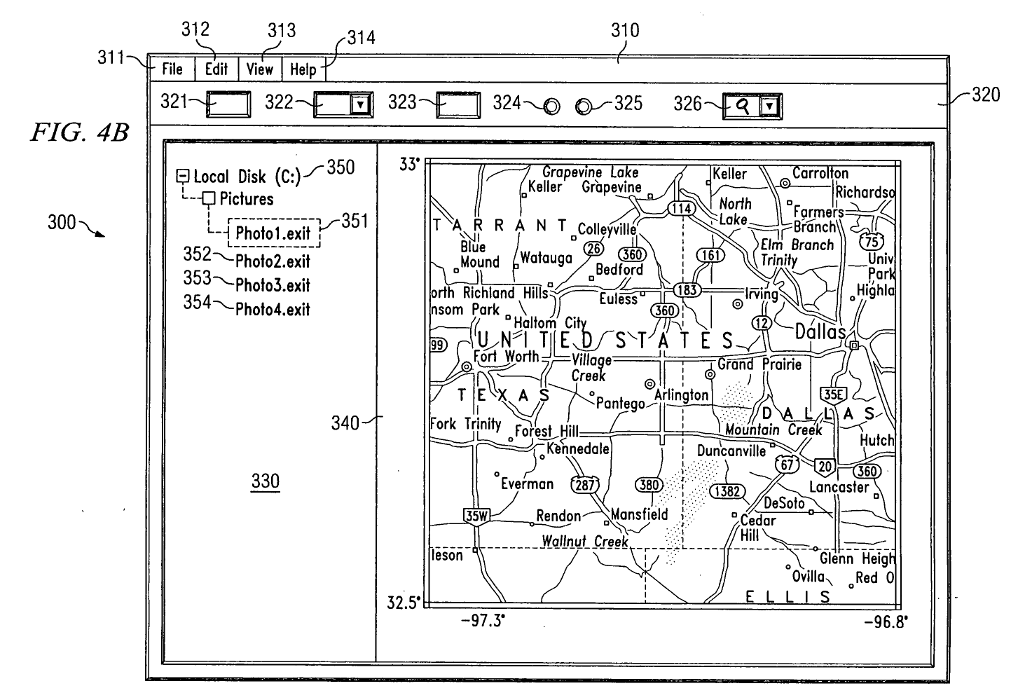

In a preferred embodiment, map 340 is displayed in a graphical user interface (GUI) 300 along with a file manager 350 as shown by the GUI 300 schematic of FIG. 4. GUI 300 is defined with a GUI data set 301 (FIG. 1) maintained in memory device 40. The exemplary GUI 300 comprises a menu bar 310, a toolbar 320, and a window 330. Menu bar 310 comprises one or more menu items 311-314 that provide a pull-down menu of user selectable items for performing a specific function. Likewise, tool bar 320 comprises user-selectable icons 321-326 that cause imaging application 160 (FIG. 1) to perform a specific action when selected by the user. Window 330 graphically displays map 340. File manager 350 is preferably implemented as a hierarchical tree with branches displaying nodes 351-354. Nodes 351-354 are identified with labels, such as a file name or other representation, of image files defined by respective data sets. For illustrative purposes, node 351 has a label of photo1.exif and is a representation of imaging data set 131.

An image file identified by one of nodes 351-354 displayed in file manager 350 is selectable and may be processed according to drag-and-drop file manipulations. The user specifies a particular image file, e.g., photo1.exif, by selecting the appropriate node 351 by moving pointer 110 over the node label and supplying a user input to, for example, mouse 22. The user then performs a drag-and-drop procedure by moving pointer 110 to a desired geographic location displayed on map 340, e.g., to the designation Dallas. An outline or shaded indication of the file label may be displayed with the moving pointer 110 to confirm that a drag-and-drop procedure is being performed. Upon positioning the pointer at the desired geographic location, the user releases the mouse button. The specified image data set and coordinates of mouse 22 are then conveyed to application 160.

In the illustrative example, the pointer 110 has x- and y-coordinates of 70 and 60, respectively. Imaging application 160 translates the x- and y-coordinates into GPS data in accordance with an embodiment of the invention. In the illustrative example, coordinate reference 132 has a longitudinal offset of −108 degrees and a latitude offset of 25 degrees and map 340 comprises a longitude scale of 16/100 and a latitude scale of 13/100. Accordingly, imaging application 160 calculates GPS values for the selected location of map 340 of:
GPSLong=−96.8 degrees=−96 degrees, 48 minutes
GPSLat=32.8 degrees=32 degrees, 48 minutes
The longitude and latitude resolution may be increased by increasing the x- and y-coordinate range associated with image map 340.

Preferably, imaging application 160 is adapted to derive latitude and longitude references from the calculated GPS values. For example, a sign of the calculated GPS longitude value is interpreted as an east or west reference in accordance with an embodiment of the invention. A positive longitude value is interpreted by application 160 as a longitude reference of east and a negative longitude value is interpreted by application 160 as a longitude reference of west, or vice versa. Likewise, a sign of the calculated GPS latitude value is interpreted by imaging application 160 as a north or south latitude reference. A positive GPS latitude value is interpreted as a north latitude and a negative GPS latitude value is interpreted as a south latitude, or vice versa. Accordingly, imaging application 160 derives the following latitude and longitude references from the calculated GPS values:
GPSLatitudeRef=N
GPSLongitudeRef=W

The GPS latitude and longitude reference values are then written into respective fields 131D₁ and 131D₃ and the unsigned GPS latitude and longitude values are written into respective fields 131D₂ and 131D₄ of data set 131 by imaging application 160.

It should be noted that geographic map 340 comprises a flat projection and equations 1 and 2 provide conversion of Cartesian coordinates of pointer 110 positioned on the flat projection of map 340. Other map projections and coordinate translation equations may be suitably substituted. Moreover, the magnification of map 340 may be modified to provide greater visual resolution of geographic features. For example, an area of map 340 shown in FIG. 4A may be selected and a “zoom” function performed to provide a greater magnification of the selected area. In the illustrative example, tool bar 320 comprises a zoom icon 326 that is selectable by the user. Upon selection of zoom icon 326, the user selects a desired area of map 340 that is subsequently magnified as shown in FIG. 4B. By providing a user selectable zoom function, smaller geographic entities may be displayed in map 340. For example, geographic landmarks, entertainment facilities, and other objects may be displayed in map 340 that are available to be selected by the user.

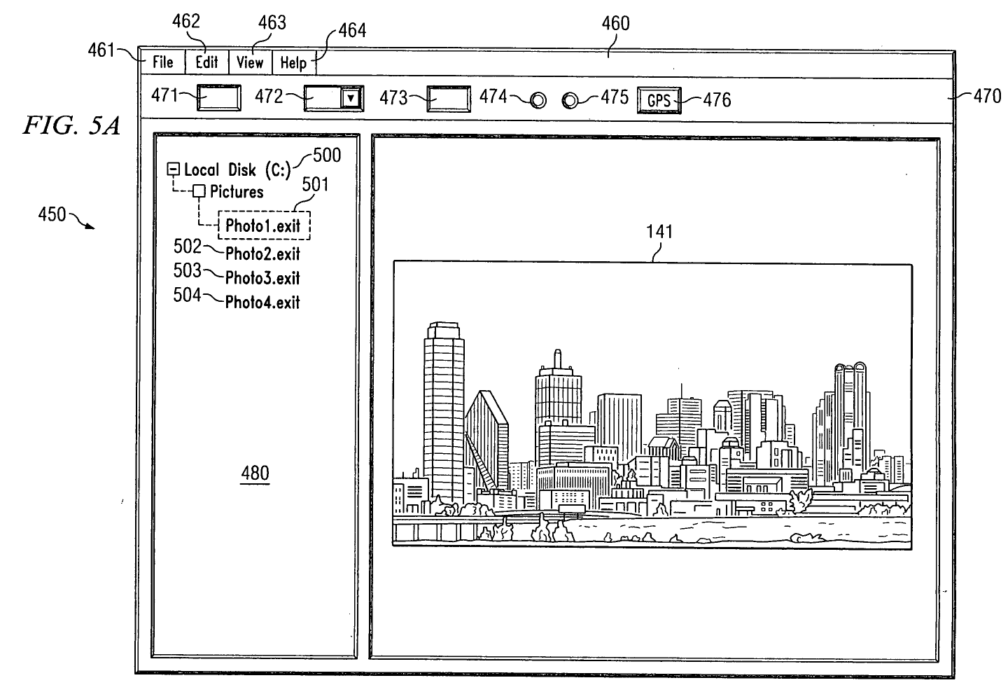

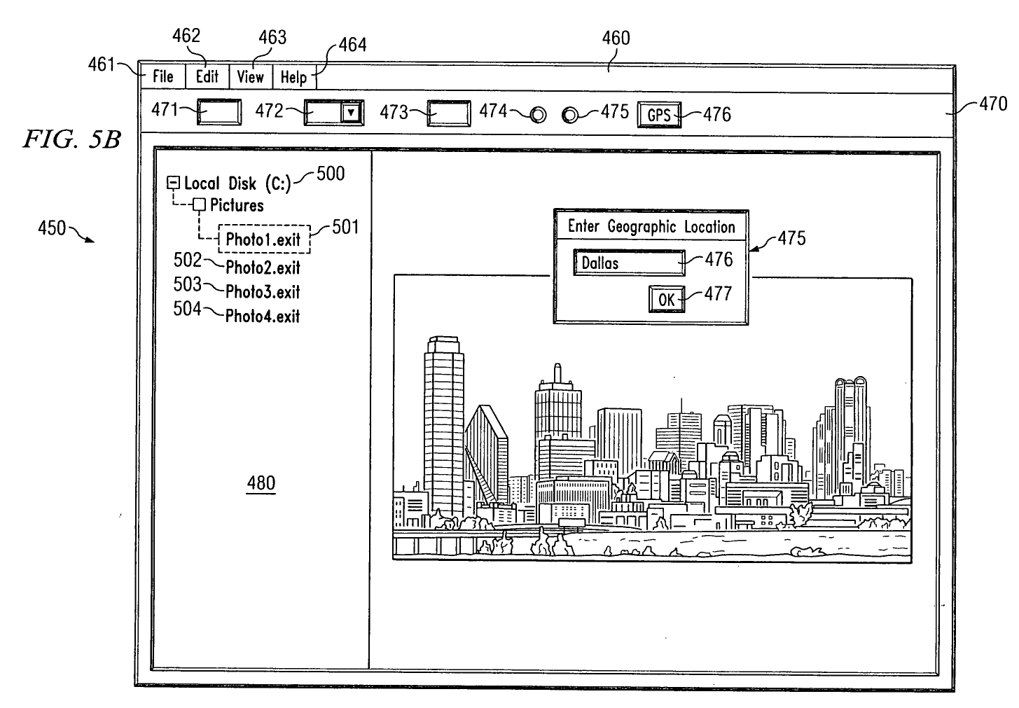

In an alternative embodiment, imaging application 160 enables user-association of GPS data with an image by way of text-entry describing a location that is used to index records of a database to evaluate the GPS location of the entered location. FIG. 5A is a schematic of a GUI 450 defined by GUI data set 301 that facilitates user-association of location data in accordance with embodiments of the invention. GUI 450 comprises a menu bar 460 having user selectable items 461-464 and a tool bar 470 having one or more user-selectable icons 471-476. A file manager 500 is displayed in GUI 450 and comprises a hierarchical tree structure of nodes 501-504 identified with labels that represent data sets or files. For illustrative purposes, node 501 has a label of photo1.exif and is a representation of data set 131.

Nodes 501-504 are selectable by the user. An image represented by one of the node 501-504 is displayed in window 480 upon user selection of the respective node 501-504. In the illustrative example, selected node 501 is representative of data set 131 and image 141 is displayed in a window 480. A dialog box 475 is invoked by, for example, user selection of tool bar icon 476 as shown by the GUI 450 schematic of FIG. 5B. Dialog box 475 comprises a text box control 476, or text box object, and a command button control 477, or button object. Text box control 476 is selectable by the user and enables a user to enter text therein. In the illustrative example, dialog box 475 includes a prompt for the user to enter a geographic location. The user selects command button control 477 upon entry of a geographic location into text box control 476. In the present example, the user has entered the text “Dallas” into text box control 476 and selects command button control 477. Selection of command button control 477 causes GUI 450 to convey the text entered in text box control 476 to application 160 for processing thereby.

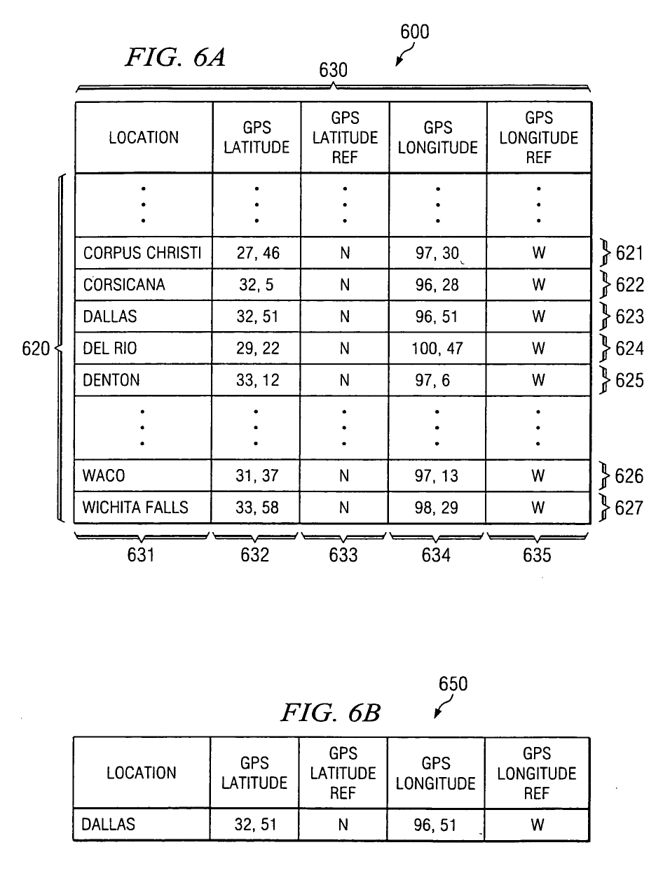

FIG. 6A is a schematic of a database or table 600 used to store geographic locations and corresponding GPS data that facilitates user-assignment of GPS data with an image in accordance with embodiments of the invention. Text supplied by the user via text box control 476 is conveyed to imaging application 160 and used as a key to table 600. Table 600 comprises a plurality of records 621-627 (collectively referred to as records 620) and fields 631-635 (collectively referred to as fields 630). Each record 620, or row, comprises an ordered set of fields 631-635. A data element may be stored in each field of a record. Respective fields 631-635 comprise data elements of a common data type, e.g., string, character, integer, etc. A field 631 is designated as a key field and each data element of key field 631 is unique. In the exemplary embodiment, key field 631 comprises data elements of a string data type. Particularly, the strings of key field 631 comprises city names. Addressing a particular record 621-627 via an associated key is referred to as indexing of record 621-627. Fields 631-635 have a respective label, or identifier, that facilitates insertion, deletion, querying, and other data operations or manipulations for performing data retrieval from table 600. Key field 631 has an identifier Location. Field 632 comprises an identifier GPSLatitude and stores latitude values of the associated locations. In the illustrative example, latitude values are stored as an integer that defines the latitude degree and an integer that defines the latitude minute. In some embodiments, a comma or other type of indicator is located between the latitude integers to delimit the latitude degrees and minutes. Field 633 comprises an identifier GPSLatitudeRef and stores data elements of a character data type that define the latitude reference of north (N) or south (S) of the associated latitude values. In the present example, all locations included in table 600 are located in the northern hemisphere and, accordingly, all GPS latitude references stored in field 633 comprise a value of “N.” In a similar manner, fields 634 and 635 comprise an identifier of GPSLongitude and GPSLongitudeRef and respectively comprise integer and character type data elements that define the longitude and longitude reference of the associated location. Particularly, each data element of field 634 comprises comma separated integer data element pairs that respectively define the longitude degree and minute of the associated location. Each data element of field 635 comprises a character data element that defines the longitude reference of the associated location as east (E) or west (W). In the present example, all locations defined by field 631 are located at western latitudes and each data element of field 635 comprises a data element of value “W.” In an alternative embodiment, latitude and longitude values may be stored in decimal notation and converted to degrees and minutes by imaging application 160 upon retrieval from table 600. In yet another embodiment, separate fields may be used for storing each of the latitude and longitude degrees, minutes, or seconds.

Application 160 performs an interrogation of table 600 from the location data supplied to text box control 476 by the user. For example, assume that table 600 has a table name of GPSDATA. Imaging application 160 may retrieve GPS data for the location specified by the user by performing an SQL SELECT similar to the following:
select*from GPSDATA where location=‘Dallas’
Execution of the table query results in a return data set 650 as shown by the data set schematic of FIG. 6B. Imaging application 160 then writes the GPSLatitude and GPSLongitude values from retrieved data set 650 into respective fields 131D₂ and 131D₄ of data set 131 and the GPSLatitudeRef and GPSLongitudeRef values of return data set 650 into fields 131D₁ and 131D₃ of data set 131. Preferably, a geographic location entered by the user may comprise any suitable geographic description. For example, the user may enter a geographic landmark, address, or other geographic entity instead of a city name. A table query is formulated from the user-supplied geographic location and corresponding GPS data is retrieved therefor and subsequently associated with the selected image data set.

If the geographic location entered by the user is not in the table, then the user may be prompted to add the specified geographic location along with a data set to the table. Thus, the user may customize the table to include locations relevant to the user.

Geographic imaging application 160, as well as table 600 and image data set 131, are preferably implemented as an instruction set(s), or program, of computer-readable logic. The instruction set is preferably maintained on any one of various conventional computer-readable mediums. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium now known or later developed.

1. A method of associating geographic data with an image data set, comprising:
receiving a user input identifying a geographic location to associate with a computer-readable image data set; and
associating the geographic location with the image data set.

2. The method according to claim 1, further comprising receiving a user input that specifies the image data set.

3. The method according to claim 1, wherein receiving a user input further comprises receiving a text entry provided by the user.

4. The method according to claim 1, further comprising displaying a map in a graphical user interface, the user input indicating the geographic location on the map.

5. The method according to claim 1, wherein receiving a user input further comprises receiving a selection of a location on a map.

6. The method according to claim 1, further comprising identifying coordinate value of a selected geographic location.

7. The method according to claim 5, wherein receiving a user input comprises receiving a user input via a touch-sensitive screen.

8. The method according to claim 6, wherein identifying a coordinate value further comprises associating a coordinate system with the map.

9. The method according to claim 5, wherein receiving a user input identifying a geographic location further comprises translating the coordinate value into a latitude and longitude.

10. The method according to claim 1, wherein associating the geographic location further comprises writing data specifying the geographic location into a field of the image data set.

11. The method according to claim 10, wherein writing the data into the field further comprises writing the data into the field having a tag identifying the field as a global positioning system field.

12. A system for associating geographic data with an image data set, comprising:
an input device operable to receive a user input provided thereto; and
a memory device adapted to store an image data set, the user input specifying geographic data that is associated with the image data set.

13. The system according to claim 12, wherein the memory device stores a data set defining a geographic map for display.

14. The system according to claim 12, the user input specifying an area of a geographic map defined by the data set.

15. The system according to claim 12, further comprising a display device for display of a graphical user interface including a map.

16. The system according to claim 12, further comprising a file manager adapted to display a representation of the image data set.

17. The system according to claim 12, the user input made by selecting a representation of the image data set displayed on a graphical user interface.

18. The system according to claim 12, the user input made by performing a drag-and-drop procedure via a graphical user interface of a representation of the image data set onto a displayed map.

19. The system according to claim 12, wherein the input device is a pointer device.

20. The system according to claim 12, further comprising a display device adapted to display a map and a pointer of a pointer device indicating a position of the map, the system adapted to translate the position of the pointer device into geographic data associated with the position of the map.

21. The system according to claim 12, wherein the input device comprises a keyboard.

22. The system according to claim 12, further comprising a table comprising records of geographic locations and associated latitude and longitude values, the system adapted to index a record with a key of a keyboard comprising the user input.

23. The system according to claim 12, wherein the input device comprises a touch-sensitive screen.

24. A computer-readable medium having stored thereon an instruction set to be executed, the instruction set, when executed by a processor, causes the processor to:
receive a user input specifying a geographic location; and
associate geographic data of the location with an image file.

25. The computer-readable medium according to claim 24, wherein the instruction set, when executed by the processor, further causes the processor to display a representation of the image file in a graphical user interface.

26. The computer-readable medium according to claim 24, wherein the instruction set, when executed by the processor, further causes the processor to display a geographic map.

27. The computer-readable medium according to claim 24, wherein the instruction set, when executed by the processor, further causes the processor to receive the user input comprising a coordinate of a pointer positioned on a map.

28. The computer-readable medium according to claim 24, wherein associating the geographic data with the image file further comprises writing the geographic data to a field of the image file.

29. The computer-readable medium according to claim 24, wherein the instruction set, when executed by the processor, further causes the processor to index a record of a table with a key comprising the user input, the geographic data retrieved from the indexed record.

30. The computer-readable medium according to claim 24, wherein the instruction set, when executed by the processor, further causes the processor to:
display a geographic map; and
translate a coordinate of a pointer displayed on an area of the map into geographic data associated with the area.
